(19) United States
(12) Patent Application Publication
(10) Pub. No.: US 2026/0099404 A1
(43) Pub. Date: Apr. 9, 2026

(54) SPEED AND ENERGY EFFICIENCY OF SELF-MANAGER DRAM MODULES WITH BUILT-IN COMPRESSION

(71) Applicant: ScaleFlux, Inc., Milpitas, CA (US)

(72) Inventors: Yang Liu, Milpitas, CA (US); Fei Sun, Irvine, CA (US); Tong Zhang, Albany, NY (US)

(21) Appl. No.: 18/910,662

(22) Filed: Oct. 9, 2024

(51) Int. Cl. G06F 11/10

(52) U.S. Cl. CPC G06F 11/1044

(57) ABSTRACT

A self-managed DRAM module and method. The module includes a plurality of DRAM chips; and a controller chip configured to store a data block received from a host according to a process that includes: compressing the data block to generate a compressed data block; performing error detection code (EDC) encoding on the compressed block and adding an EDC redundancy to the compressed block; partitioning the compressed block with the EDC redundancy into a set of m data chunks; performing error correction code (ECC) encoding on each of the m data chunks to generate m codewords; and writing the m codewords to the DRAM chips.

### TECHNICAL FIELD

The present invention relates to the field of solid-state memory, and particularly to improving the speed and energy efficiency of DRAM (dynamic random-access memory) modules.

### BACKGROUND

Modern computers use DRAM (dynamic random-access memory) chips to implement memory systems. In conventional practice, each CPU chip connects to its exclusively owned/controlled DRAM modules, typically in the form of DIMM (dual in-line memory module), through dedicated DDR (double data rate) channels. Each CPU chip incorporates one or multiple DRAM controllers, and each DRAM controller is responsible for controlling all the DRAM chips on one DDR channel. As a result, the number of DRAM controllers inside a CPU chip determines the maximum DRAM capacity and bandwidth that are directly available to the CPU. Due to the high implementation complexity of DRAM controllers and hardware resources (e.g., the CPU chip pins) consumed by each DDR channel, modern CPUs can only integrate a relatively small number (e.g., 8 or 12) of DRAM controllers, leading to a limited DRAM capacity and bandwidth that are directly available to the CPU. Meanwhile, it is very difficult for a group of CPUs to share/pool their DRAM resources to improve the overall memory utilization efficiency.

To facilitate the DRAM capacity/bandwidth expansion and pooling/sharing, the computing industry has developed open standards, in particular CXL (compute express link), that allow CPU-memory connections over high-speed PCIe links. In this context, much of DRAM control/management functionalities are migrated from CPUs into the DRAM modules, leading to self-managed DRAM modules in contrast to the conventional CPU-managed DRAM modules. Because modern CPUs could communicate with other devices through many PCIe lanes/channels, CPUs could connect to many self-managed DRAM modules (e.g., CXL-based DRAM modules) to expand their memory capacity/bandwidth. Moreover, unlike conventional CPU-managed DRAM modules, one self-managed DRAM module can directly connect to multiple CPUs. Hence a self-managed DRAM module could be easily shared among multiple CPUs, which allows multiple CPUs pool memory resources together to improve the overall memory utilization efficiency.

### SUMMARY

Accordingly, an embodiment of the present disclosure is directed to methods for reducing ECC-induced energy consumption and bandwidth utilization degradation of self-managed DRAM modules in computing systems.

One aspect provides a self-managed dynamic random-access memory (DRAM) module, comprising: a plurality of DRAM chips; and a controller chip configured to store a data block received from a host according to a process that includes: compressing the data block to generate a compressed data block; performing error detection code (EDC) encoding on the compressed block and adding an EDC redundancy to the compressed block; partitioning the compressed block with the EDC redundancy into a set of m data chunks; performing error correction code (ECC) encoding on each of the m data chunks to generate m codewords; and writing the m codewords to the DRAM chips.

Another aspect includes a method of storing a data block received from a host in a self-managed dynamic random-access memory (DRAM) module, comprising: compressing the data block to generate a compressed data block; performing error detection code (EDC) encoding on the compressed block and adding an EDC redundancy to the compressed block; partitioning the compressed block with the EDC redundancy into a set of m data chunks; performing error correction code (ECC) encoding on each of the m data chunks to generate m codewords; and writing the m codewords to a set of DRAM chips in the self-managed DRAM module.

### BRIEF DESCRIPTION OF THE DRAWINGS

The numerous advantages of the present invention may be better understood by those skilled in the art by reference to the accompanying figures in which:

FIG. 1 illustrates a CPU connecting to both CPU-managed DRAM modules through DDR channel and self-managed DRAM modules through CXL/PCIe channel in accordance with embodiments.

FIG. 2 illustrates the architecture of a self-managed DRAM module that supports data compression in accordance with embodiments.

FIG. 3 illustrates one ECC codeword being stored across all the n+2 DRAM chips on one DDR channel in accordance with embodiments.

FIG. 4 illustrates that all the DRAM chips on the same DDR channel share the same address bus and collectively form the data bus in accordance with embodiments.

FIG. 5 illustrates the under-utilization of DRAM bandwidth for transferring data in accordance with embodiments.

FIG. 6 illustrates a system that realizes almost 100% DRAM bandwidth for transferring compressed blocks by adding error detection code (EDC) to each compressed block in accordance with embodiments.

FIG. 7 illustrates the operational flow diagram of fetching/decompressing one compressed block in accordance with embodiments.

FIG. 8 illustrates the re-organization of compressed block and ECC redundancy in accordance with embodiments.

FIG. 9 illustrates the storage of each segment of (n+2)·b-byte data or ECC coding redundancy over the (n+2) DRAM chips on one DDR channel in accordance with embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Reference will now be made in detail to embodiments of the invention, examples of which are illustrated in the accompanying drawings.

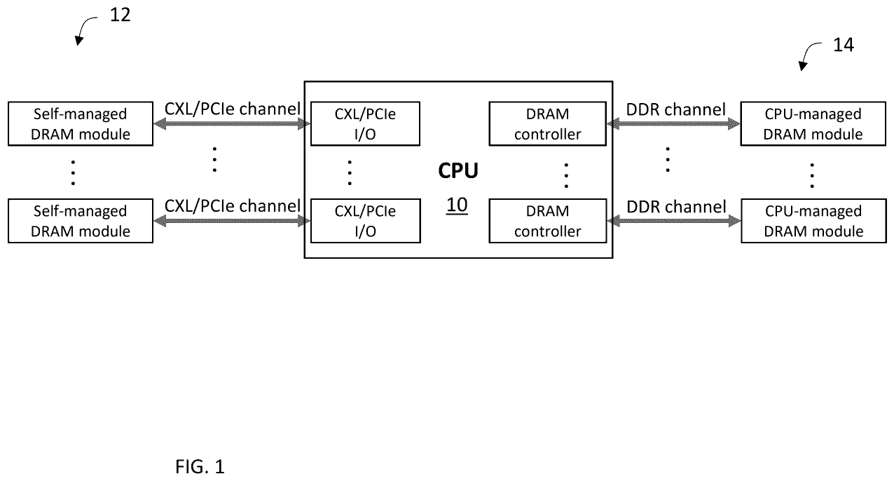

FIG. 1 illustrates a CPU (also referred to herein as host, host processors, or CPU chip) 10 connected with both CPU-managed DRAM modules 14 through DDR channels and self-managed DRAM modules 12 through CXL/PCIe channels. All the DRAM modules 14 on one DDR channel are fully controlled/managed by one DRAM controller inside the CPU chip 10. Using an integrated CXL/PCIe I/O engine (that is much simpler than a DRAM controller), the CPU connects to one self-managed DRAM module 12 through a CLX/PCIe channel. Each self-managed DRAM module 12 internally controls/manages the DRAM chips on its own and serves requests (e.g., data read and write) from host processors through the CXL/PCIe channel.

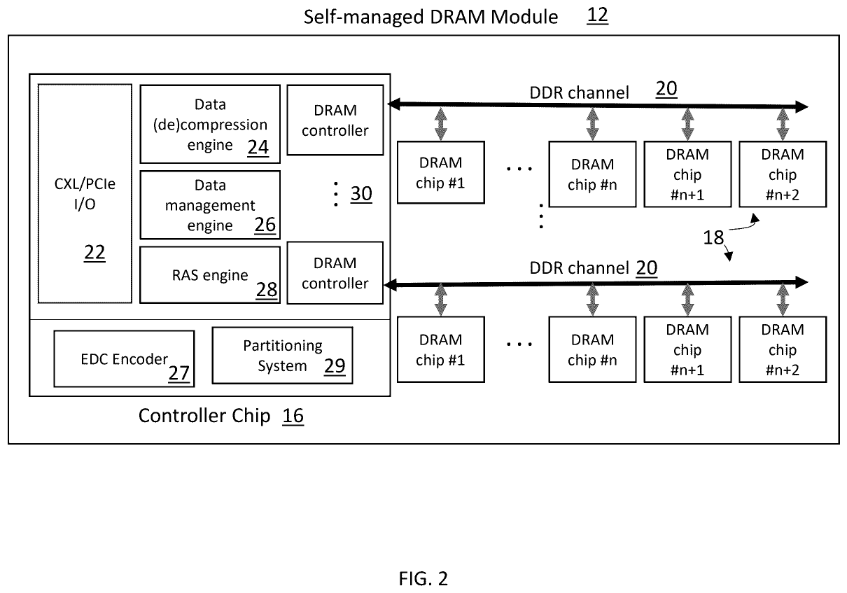

FIG. 2 illustrates the architecture of a self-managed DRAM module 12 that performs internal data compression, which makes it possible to deploy lossless data compression to expand the usable memory capacity at zero cost overhead. The controller chip 16 inside self-managed DRAM module 12 is responsible for data compression/decompression, being transparent to host CPUs 10. To achieve high compression ratio, lossless data compression should be performed in the unit of large block size (e.g., 1 KB, 2 KB, or 4 KB). Meanwhile, to improve data storage reliability and tolerate DRAM device failures, self-managed DRAM module 12 needs to implement error correction coding (ECC) at the cost of higher operational energy consumption and lower DRAM bandwidth utilization efficiency. Embodiments described herein reduce ECC-induced energy consumption and bandwidth utilization degradation of self-managed DRAM module 12.

By reducing the data in-memory footprint, lossless data compression can reduce the effective memory bit cost. Self-managed DRAM module 12 can internally implement data compression, transparent to host processors. Since in-memory data tend to have high compressibility (e.g., compression ratio of 2:1 and above), compression-capable self-managed DRAM module 12 can achieve significant memory cost reduction.

As shown, self-managed DRAM module 12 contains a controller chip 16 and multiple DRAM chips. All the DRAM chips 18 are organized into multiple DDR channels 20, where each channel contains n+2 DRAM chips (n=8 when using latest DDR5 DRAM chips). As illustrated in FIG. 2, the controller chip 16 contains (i) a CXL/PCIe I/O engine 22 to communicate with host processors, (ii) multiple DRAM controllers 30, each one controls all the n+2 DRAM chips on one DDR channel, (iii) data compression and decompression engine 24 that performs data compression and decompression, (iv) data management engine 26 that manages the storage of compressed data blocks on DRAM chips, and (v) RAS (reliability, availability, and serviceability) engine 28 that is responsible for the reliability, availability, and serviceability of the entire self-managed DRAM module 12. To ensure the data storage reliability, the RAS engine 28 protects data with an ECC (error correction code), where ECC coding redundancy should cover two DRAM chips on each channel to tolerate a catastrophic failure of one DRAM chip. Therefore, in a tradition approach, among the total n+2 DRAM chips on each DDR channel, n chips store user data and two chips store ECC coding redundancy. Controller chip 16 also include an EDC encoder 27 and partitioning system 29, which assist in performing aspects of the described embodiments.

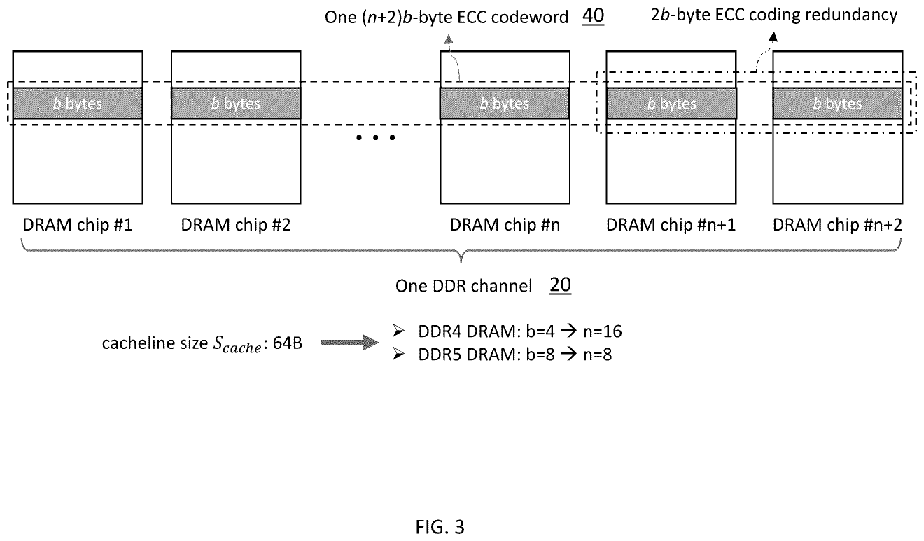

As shown in FIG. 3, each ECC codeword 40 contains total (n+2)·b bytes: Each DRAM chip stores b bytes of each ECC codeword that uses 2b-byte coding redundancy to protect (n·b)-byte user data.

Host processors 10 access the self-managed DRAM module 12 in the unit of cachelines and let S_{cache} denote the number of bytes in each cacheline. Therefore, inside self-managed DRAM module 12, we have n·b=S_{cache}, where n is the number of chips in the DDR channel and b is the number of bytes in each chip. Most CPUs set the cacheline size as 64 B (i.e., S_{cache}=64). Hence, we have n·b=64. Meanwhile, different types of DRAM chips (e.g., DDR4 and DDR5 DRAM) have different value of b (e.g., b is 4 in DDR4 DRAM and 8 in DDR5 DRAM). Accordingly, the number of DRAM chips on each DDR channel 20 is different when using different types of DRAM chips (as shown in FIG. 3):
When using DDR4 DRAM chips, given n·b=64 and b=4, we have n=16 and hence each DDR channel 20 contains total n+2=16+2=18 DDR4 DRAM chips. In this case, each ECC codeword contains total (n+2)·b=18·4=72 bytes and uses 2b=8 bytes of coding redundancy to protect 64-byte cacheline.
When using DDR5 DRAM chips, given n·b=64 and b=8, we have n=8 and hence each DDR channel 20 contains total n+2=8+2=10 DDR5 DRAM chips. In this case, each ECC codeword contains total (n+2)·b=10 8=80 bytes and uses 2b=16 bytes of coding redundancy to protect 64-byte cacheline.

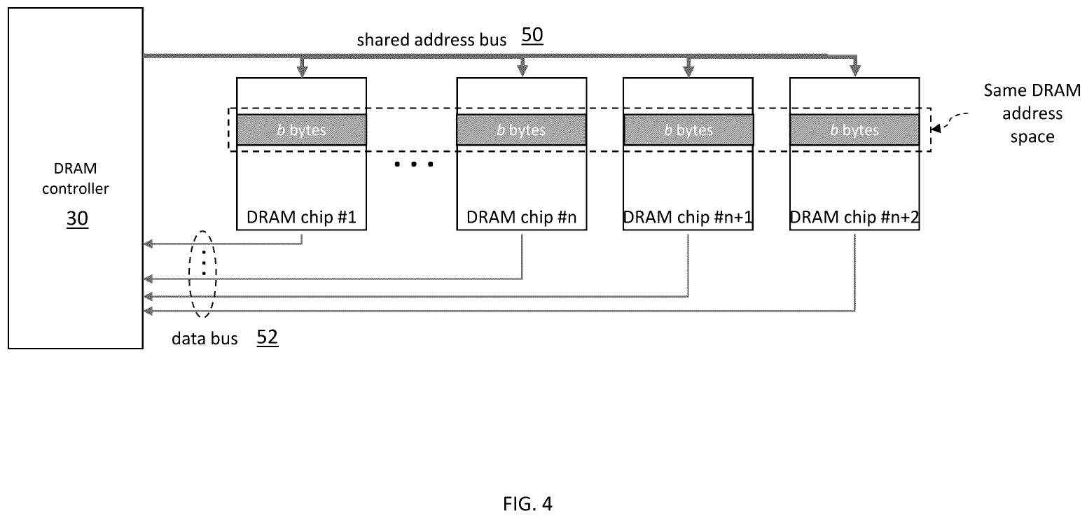

As illustrated in FIG. 4, on each DDR channel, all the n+2 DRAM chips share the same address from the DRAM controller 30 through a common shared address bus 50 and collectively form a data bus 52. Hence, each (n+2)·b-byte ECC codeword is stripped over n+2 DRAM chips and occupies the same b-byte address space in each DRAM chip.

Since data compression ratio tends to improve as the compression block size increases, self-managed DRAM module 12 should ideally perform data compression in the unit of a relatively large block size (e.g., 1 KB or 4 KB) to achieve a high compression ratio (e.g., 2:1 and above). As discussed above, host processors 10 access self-managed DRAM module 12 using of cachelines with the typical size of 64 B. The cacheline size versus compression block size mismatch (e.g., 64 B vs. 4 KB) inevitably causes significant DRAM read/write amplification inside self-managed DRAM modules. For instance, let Spik denote the number of bytes of each compression block (e.g., 1 KB or 4 KB). To serve a cacheline read (or write) request from host processors, self-managed DRAM modules must internally read/decompress (or read/decompress/modify/compress) an S_{blk}-byte data block from DRAM chips, leading to read/write amplification of

$$\frac{{S}_{b l k}}{{S}_{c a c h e}} .$$

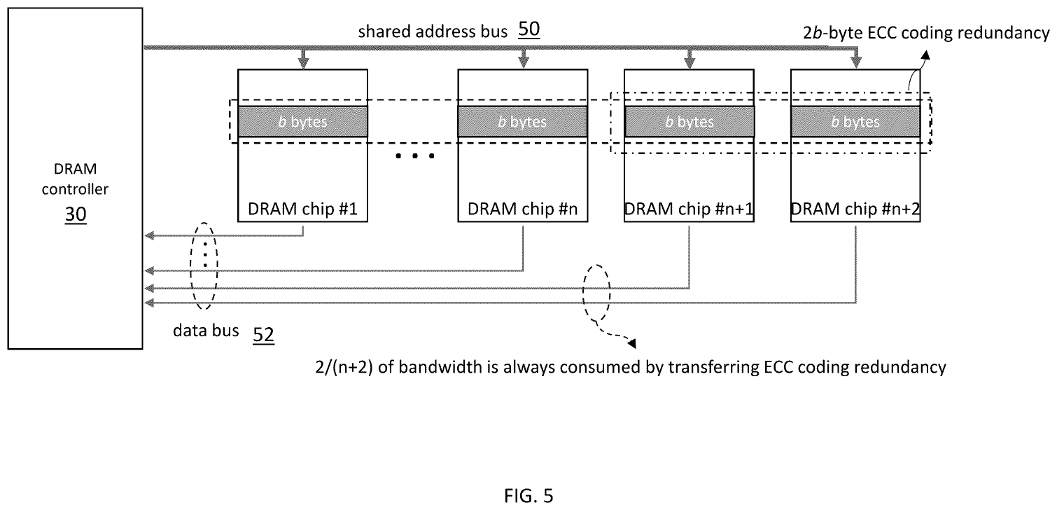

FIG. 5 shows the operational system of serving a read or write request from host processors. For examples, given 64-byte cachelines and 4 KB compression blocks, the internal DRAM read/write amplification is

$$\frac{{S}_{b l k}}{{S}_{c a c h e}} = \frac{4 K}{64} = 64 .$$

Such a high internal read/write amplification will significantly degrade the DRAM data access bandwidth utilization efficiency and hence degrade the speed performance of self-managed DRAM modules on serving read/write requests from host processors.

Techniques are herein described to increase the DRAM access bandwidth utilization efficiency and hence improve the speed performance of self-managed DRAM module 12 on serving host processors' read/write requests. The approach is to reduce the ECC-induced DRAM access bandwidth usage overhead. Let B_{DRAM} denote the data transfer bandwidth of each DRAM chip. Hence, given the n+2 DRAM chips on each channel, the aggregated channel data transfer bandwidth is (n+2)·B_{DRAM}. As discussed above and illustrated in FIG. 3 and FIG. 4, each (n+2)·b-byte ECC codeword is always fetched from DRAM altogether from the n+2 DRAM chips. As a result, when reading data from DRAM, only

$$\frac{n}{n + 2}$$

of the channel bandwidth is used for transferring user data, while the other

$$\frac{2}{n + 2}$$

of the channel bandwidth is consumed by transferring ECC coding redundancy, as illustrated in FIG. 5. Hence, from the host processors' perspective, the DRAM bandwidth utilization is

$$\frac{n}{n + 2} .$$

When using DDR5 DRAM (i.e., n=8), the DRAM bandwidth utilization is only 80%.

The following technique aims to enable self-managed DRAM module 12 with built-in data compression to utilize almost 100% of their internal DRAM data transfer bandwidth for transferring compressed data blocks (i.e., almost 0% of their internal DRAM data transfer bandwidth for transferring ECC coding redundancy). First, note that, under normal operational conditions (e.g., temperature, supply voltage), DRAM chips have a very low bit error rate (i.e., most of time the data being transferred from DRAM chips to the controller do not contain any bit errors). Hence, most of the time, the 2b-byte ECC coding redundancy is only used to verify the correctness of its associated n·b-byte data, leaving the error correction capability unutilized. As discussed above, one compressed block is much larger than the host processor cacheline size of S_{cache}=n·b bytes. Assuming one compressed block contains m cachelines, e.g., given a 64 B cacheline size, one 1 KB compressed block contains

$$m = \frac{1 KB}{64 B} = 16$$

cachelines. Hence, one compressed block is stored into DRAM as m ECC codewords. Since each compressed block should be fetched altogether for decompression, it is not necessary to verify the correctness of each individual ECC codeword among all the m ECC codewords. Instead, the current approach only needs to verify the correctness of the entire compressed block. Hence, by verifying the correctness of the entire compressed block without using the ECC coding redundancy of all the m ECC codewords, the DRAM controller 30 does not have to fetch the ECC coding redundancy from the DRAM chips, which will help to improve the DRAM bandwidth utilization efficiency. To implement this technique, controller chip 16 is configured to add a single error detection code for each entire compressed block.

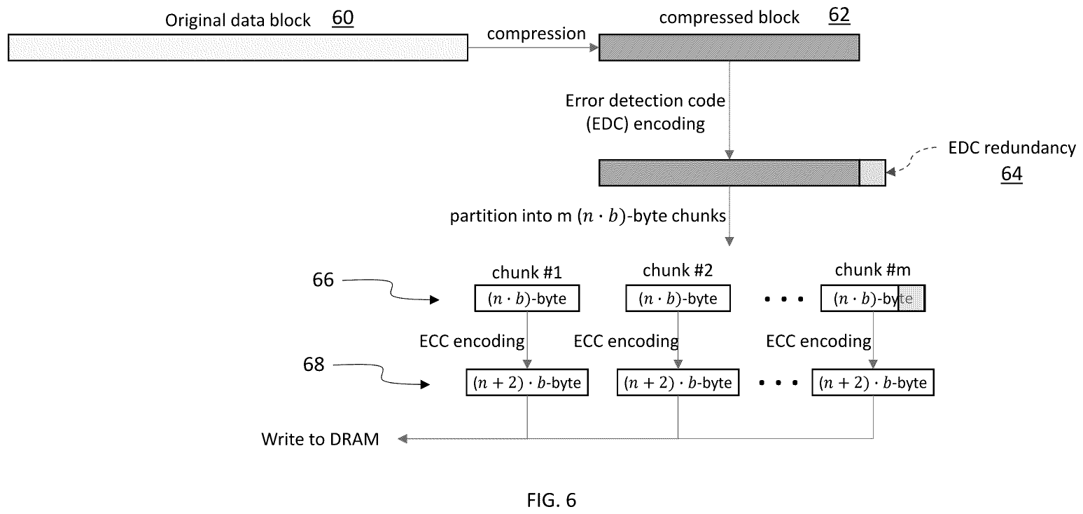

As illustrated in FIG. 6, after the controller chip 16 compresses one data block 60 (e.g., 4 KB block) to generate a compressed block 62, the controller chip 16 utilized EDC encoder 27 (FIG. 1) to perform error detection encoding (e.g., CRC (cyclic redundancy check) code encoder) to generate a d-byte EDC (error detection code) redundancy 64 for the compressed block 62. The value of d can be relatively small (e.g., 8 or 16 bytes) compared with the compressed block size. Next the compressed block containing the EDC 64 is partitioned into m (n*b)-byte data chunks 66 by partitioning system 29 (FIG. 1). ECC encoding is them performed on each data chunk 66 to generate m codewords 68, which are then written to DRAM. The partitioning information, which for example may include size and/or location of each partition, location of EDC and ECC coding redundancy, etc., may for example be stored by the partitioning system 29 in a small amount of memory.

For example, suppose the compressed block 62 contains l_{blk} bytes. The chip 16 partitions the (l_{blk}+d)-byte block into groups of (S_{cache}=n·b)-byte size chunks and applies ECC encoding to each chunk to generate a set of (n+2)·b-byte ECC codewords 68. After which the chip 16 writes all the ECC codewords 68 to DRAM chips.

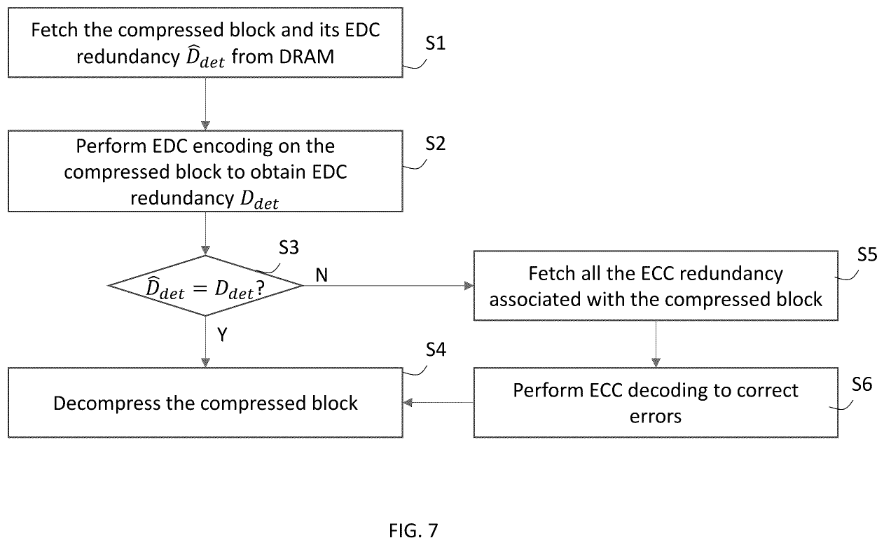

FIG. 7 depicts a process flow for reading the data block 60 with reference to FIG. 6. When the DRAM controller 30 needs to fetch/decompress one compressed block 62, it first fetches the compressed block 62 and its d-byte EDC redundancy 64 from DRAM chips without fetching any ECC coding redundancy at S1 (i.e., chunks 66). Since d is much smaller than the compressed block size, almost 100% of DDR channel bandwidth is used for transferring the compressed data block, leading to almost 100% DRAM bandwidth utilization efficiency. As shown in FIG. 7, after the controller has fetched the compressed block and its d-byte EDC redundancy denoted as \hat{D}_{det}, at S2 the chip 16 performs EDC encoding on the compressed block to generate a new d-byte EDC redundancy denoted as D_{det}. At S3, the controller compares \hat{D}_{det} and D_{det} to verify the correctness of the compressed data block fetched from DRAM. If \hat{D}_{det} and D_{det} are identical, then the compressed data block does not contain any errors, and the controller decompresses the data block at S4 and accordingly serves the host read/write request. Otherwise, if \hat{D}_{det} and D_{det} are not identical, then the compressed data block contains errors. Accordingly, the controller then at S5 fetches all the ECC redundancy associated with this data block and perform ECC decoding at S6 to correct the errors, before decompressing the compressed data block at S4.

Note that if each ECC codeword is stored over the same address space of all the (n+2) DRAM chips as shown above in FIG. 5, the controller must fetch each ECC codeword entirely (including (n·b)-byte data and 2b-byte ECC coding redundancy). This will prevent the controller from only fetching compressed blocks without ECC coding redundancy (i.e., data chunks 66), which will make it challenging to implement the above method illustrated in FIG. 7. To solve this problem, a method is provided to disaggregate the in-memory storage of (n·b)-byte data and its 2b-byte ECC coding redundancy is provided. Define

$${d}_{1} = \frac{n}{gcd ( n , n + 2 )} , {d}_{2} = \frac{n}{gcd ( n , 2 )}$$

where gcd(a, b) represents the greatest common devisor (GCD) of a and b. Moreover, define d=lcm(d₁, d₂), where lcm(a, b) represents the least common multiple (LCM) of a and b. Finally, define

$$s = \frac{d \cdot ( n + 2 )}{n} .$$

For example, each DDR5 DRAM channel contains n+2=8+2=10 DDR5 DRAM chips with n=8, where we have

$${d}_{1} = \frac{n}{gcd ( n , n + 2 )} = \frac{8}{gcd ( 8 , 10 )} = \frac{8}{2} = 4 ,$$

$${d}_{2} = \frac{n}{gcd ( n , 2 )} = \frac{8}{gcd ( 8 , 2 )} = \frac{8}{2} = 4$$

and d=lcm(d₁, d₂)=lcm(4,4)=4. Therefore, we have that

$$s = \frac{d \cdot ( n + 2 )}{n} = 4 \cdot \frac{10}{8} = 5 .$$

For each group of s ECC codewords, where each ECC codeword contains (n·b)-bytes of data and 2b-bytes of ECC coding redundancy, there is a total of (s·n·b)-bytes of data and a total (2·s·b)-bytes of ECC coding redundancy.

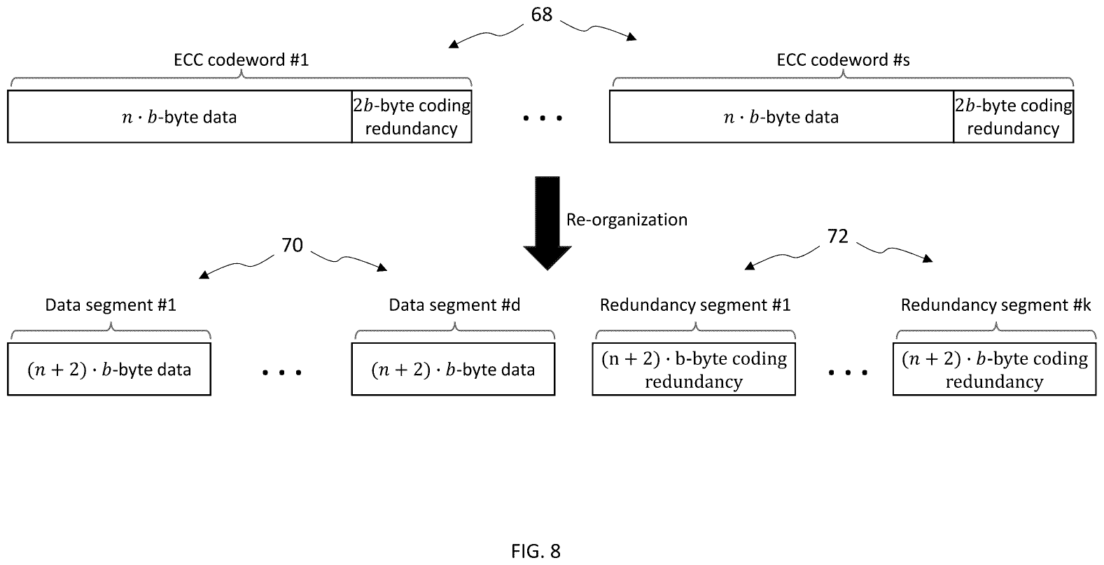

As illustrated in FIG. 8, the chip partitions (i.e., re-organizes) the total (s·n·b)-bytes of data (i.e., the codewords 68) into

$$d = \frac{s \cdot n}{( n + 2 )}$$

data segments 70 (recall that

$$s = \frac{d \cdot ( n + 2 )}{n} ) ,$$

each segment 70 contains (n+2)·b-byte data, and partitions the total (2·s·b)-byte ECC coding redundancy into

$$k = \frac{2 \cdot s}{( n + 2 )}$$

ECC redundancy segments 72, each segment 72 contains (n+2)·b-byte ECC coding redundancy. Re-organizing the codewords 68 in this manner can for example be implemented by partitioning system 29 (FIG. 1).

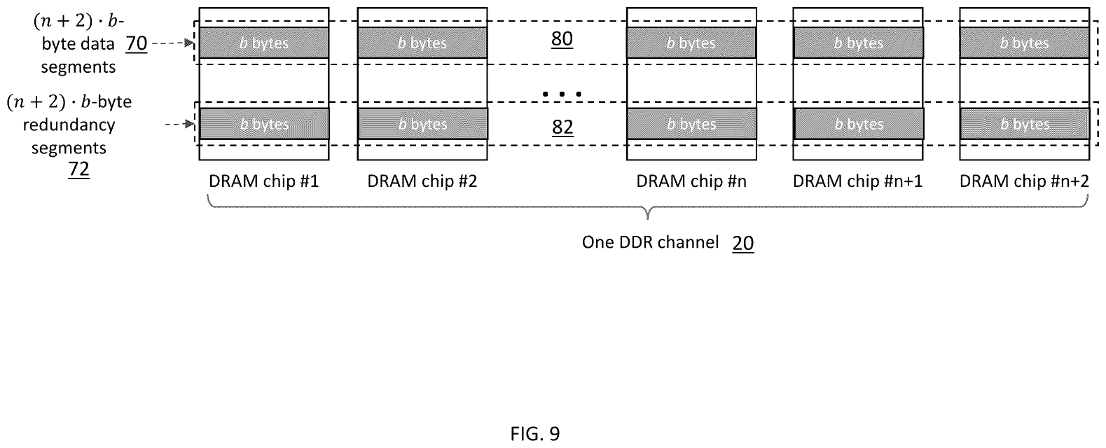

As illustrated in FIG. 9, the DRAM controller stores each data segment 70 of (n+2)·b-bytes altogether at the same address space and stores each ECC coding redundancy 72 altogether at another address space, both over the (n+2) DRAM chips on one DDR channel. This is fundamentally different from current practice:
In current practice, as shown in FIG. 5, each (n+2)·b-byte ECC codeword is stored at the same address space over the (n+2) DRAM chips on one DDR channel. As a result, when fetching the n·b-byte data in one ECC codeword, DRAM controller must fetch the associated 2b-byte ECC coding redundancy concurrently. This will make it difficult to implement the technique as discussed above.
When using the proposed design approach as illustrated in FIG. 8, the chip stores data segments 70 and their ECC redundancy segments 72 separately from each other at different DRAM address spaces 80, 82 in one DDR channel 20. This makes it possible to implement the proposed method (as illustrated in FIG. 6 and FIG. 7) that can utilize almost 100% DRAM data transfer bandwidth for transferring compressed data blocks.

While the above presented design can effectively leverage the very low DRAM error rate to realize almost 100% DRAM bandwidth utilization for transferring compressed data blocks, note the following. In the case where DRAM errors indeed occur, the DRAM controller must fetch all the (2·s·b)-byte ECC coding redundancy associated with the compressed block, even though most likely only few ECC codewords contain errors and need ECC decoding. To reduce the overhead caused by fetching ECC coding redundancy from DRAM, the above design solution can be extended as follows.

Instead of using a single error detection code (EDC) 64 for the entire compressed block 62 (as shown in FIG. 6), the chip 16 can partition the compressed block 62 into multiple sub-blocks and apply an EDC to each sub-block individually (i.e., individual EDC redundancy). Accordingly, as the chip fetches/decompresses one compressed block, once the chip has fetched one sub-block and its associated EDC redundancy, it will perform an EDC encoding to verify the correctness of current sub-block and, if errors are detected, it will fetch all the ECC coding redundancy associated with this sub-block for ECC decoding. If no errors occur, it will decompress the sub-block and repeat and process for the next sub-block until all blocks are decompressed.

It is understood that aspects of the present disclosure may be implemented in any manner, e.g., hardware, computer chips, as a software/firmware program, an integrated circuit board, a controller card, etc., that includes a processing core, I/O, memory and processing logic. Aspects may be implemented in a combination of hardware and software. Aspects of the processing logic may be implemented using field programmable gate arrays (FPGAs), application specific integrated circuit (ASIC) devices, and/or other hardware-oriented systems.

Aspects also may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on a host computer, partly on a host computer, on a remote computing device (e.g., a memory card) or entirely on the remote computing device. In the latter scenario, the remote computing device may be connected to the host computer through any type of interface or network. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to control electronic circuitry in order to perform aspects of the present disclosure.

Computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A self-managed dynamic random-access memory (DRAM) module, comprising:
a plurality of DRAM chips; and
a controller chip configured to store a data block received from a host according to a process that includes:
compressing the data block to generate a compressed data block;
performing error detection code (EDC) encoding on the compressed block and adding an EDC redundancy to the compressed block;
partitioning the compressed block with the EDC redundancy into a set of m data chunks;
performing error correction code (ECC) encoding on each of the m data chunks to generate m codewords; and
writing the m codewords to the DRAM chips.

2. The self-managed DRAM of claim 1, wherein each data chunk includes (n*b) bytes, where n+2 is a number of chips in a DDR (double data rate) channel and b is a number of bytes to be stored in each chip of the DDR channel.

3. The self-managed DRAM of claim 2, wherein each codeword includes (n+2)*b bytes.

4. The self-managed DRAM of claim 1, wherein reading the data block includes:
fetching the compressed block with the EDC redundancy from the DRAM chips;
performing EDC encoding on the compressed block to generate a new EDC redundancy;
comparing the EDC redundancy with the new EDC redundancy;
in response to the EDC redundancy and new EDC redundancy being equal, decompressing the compressed block and serving a decompressed data block; and
in response to the EDC redundancy and new EDC redundancy being unequal, fetching an ECC redundancy associated with the compressed block, performing ECC decoding to correct errors, decompressing the compressed block, and serving a decompressed data block.

5. The self-managed DRAM of claim 1, wherein each of the m codewords includes data and ECC redundancy, and wherein writing the m codewords to the DRAM chips includes re-organized the m codewords into (1) a set of data segments that include only data from the m codewords and (2) a set of redundancy segments that include only ECC redundancy from the m codewords.

6. The self-managed DRAM of claim 5, wherein the data segments include (n+2)*b bytes of data, and the redundancy segments include (n+2)*b bytes of ECC redundancy.

7. The self-managed DRAM of claim 6, wherein the data segments and redundancy segments are stored at different addresses over n+2 DRAM chips on one DDR channel.

8. The self-managed DRAM of claim 1, wherein performing EDC encoding to the compressed block includes:
partitioning the compressed block into a plurality of sub-blocks; and
performing EDC encoding on each sub-block and adding an individual EDC redundancy to each sub-block.

9. The self-managed DRAM of claim 8, wherein reading the data block includes:
fetching a first sub-block and the individual EDC redundancy;
performing EDC encoding to verify a correctness of the first sub-block;
in response to detected errors, fetching an ECC redundancy associated with the first sub-block for ECC decoding, correcting the detected errors and decompressing the first sub-block; and
in response to no detected errors, decompressing the first sub-block.

10. The self-managed DRAM of claim 9, wherein reading the data block further includes:
fetching a next sub-block and an associated individual EDC redundancy;
performing EDC encoding to verify a correctness of the next sub-block;
in response to detected errors, fetching the ECC redundancy associated with the next sub-block for ECC decoding, correcting the detected errors and decompressing the next sub-block; and
in response to no detected errors, decompressing the next sub-block.

11. A method of storing a data block received from a host in a self-managed dynamic random-access memory (DRAM) module, comprising:
compressing the data block to generate a compressed data block;
performing error detection code (EDC) encoding on the compressed block and adding an EDC redundancy to the compressed block;
partitioning the compressed block with the EDC redundancy into a set of m data chunks;
performing error correction code (ECC) encoding on each of the m data chunks to generate m codewords; and
writing the m codewords to a set of DRAM chips in the self-managed DRAM module.

12. The method of claim 11, wherein each data chunk includes (n*b) bytes, where n+2 is a number of chips in a DDR (double data rate) channel and b is a number of bytes to be stored in each chip of the DDR channel.

13. The method of claim 12, wherein each codeword includes (n+2)*b bytes.

14. The method of claim 11, wherein reading the data block includes:
fetching the compressed block with the EDC redundancy from the DRAM chips;
performing EDC encoding on the compressed block to generate a new EDC redundancy;
comparing the EDC redundancy with the new EDC redundancy;
in response to the EDC redundancy and new EDC redundancy being equal, decompressing the compressed block and serving a decompressed data block; and
in response to the EDC redundancy and new EDC redundancy being unequal, fetching an ECC redundancy associated with the compressed block, performing ECC decoding to correct errors, decompressing the compressed block, and serving a decompressed data block.

15. The method of claim 11, wherein each of the m codewords includes data and ECC redundancy, and wherein writing the m codewords to the DRAM chips includes re-organized the m codewords into (1) a set of data segments that include only data from the m codewords and (2) a set of redundancy segments that include only ECC redundancy from the m codewords.

16. The method of claim 15, wherein the data segments include (n+2)*b bytes of data, and the redundancy segments include (n+2)*b bytes of ECC redundancy.

17. The method of claim 16, wherein the data segments and redundancy segments are stored at different addresses over n+2 DRAM chips on one DDR channel.

18. The method of claim 11, wherein performing EDC encoding to the compressed block includes:
partitioning the compressed block into a plurality of sub-blocks; and
performing EDC encoding on each sub-block and adding an individual EDC redundancy to each sub-block.

19. The method of claim 18, wherein reading the data block includes:
fetching a first sub-block and the individual EDC redundancy;
performing EDC encoding to verify a correctness of the first sub-block;
in response to detected errors, fetching an ECC redundancy associated with the first sub-block for ECC decoding, correcting the detected error and decompressing the first sub-block; and
in response to no detected errors, decompressing the first sub-block.

20. The method of claim 19, wherein reading the data block further includes:
fetching a next sub-block and an associated individual EDC redundancy;
performing EDC encoding to verify a correctness of the next sub-block;
in response to detected errors, fetching the ECC redundancy associated with the next sub-block for ECC decoding, correcting the detected error and decompressing the next sub-block; and
in response to no detected errors, decompressing the next sub-block.
